(19) United States
(12) Patent Application Publication
(10) Pub. No.: US 2025/0308086 A1
(43) Pub. Date: Oct. 2, 2025

(54) INFORMATION PROCESSING APPARATUS AND INFORMATION PROCESSING METHOD FOR DRAWING COMPOSITE IMAGE

(71) Applicant: CANON KABUSHIKI KAISHA, Tokyo (JP)

(72) Inventor: KOUSHI TAKEMURA, Kanagawa (JP)

(21) Appl. No.: 19/079,601

(22) Filed: Mar. 14, 2025

(30) Foreign Application Priority Data
Mar. 29, 2024 (JP) 2024-055620

(51) Int. Cl. G06T 11/00

(52) U.S. Cl. CPC G06T 11/00; G06T 2210/62

(57) ABSTRACT

An information processing apparatus acquires a first layer including a first image in which a translucent object is drawn and first depth information that corresponds to the first image. The information processing apparatus acquires a second layer including a second image in which an opaque object is drawn and second depth information that corresponds to the second image. The information processing apparatus acquires a third layer including a third image in which a real object, which is placed in a real space, is drawn and third depth information that corresponds to the third image. The information processing apparatus draws a composite image in which the first image, the second image, and the third image are combined on a basis of the first depth information, the second depth information, and the third depth information.

### BACKGROUND OF THE INVENTION

### Field of the Invention

The present invention relates to an information processing apparatus and an information processing method.

### Description of the Related Art

In recent years, head-mounted displays (hereinafter, referred to as “HMDs”) worn by users on their heads have been widely used. The users can easily experience mixed reality (hereinafter, referred to as “MR”) by using the HMDs.

Japanese Patent Application Laid-open No. 2015-170232 discloses a technique for providing an image experience without any sense of incongruity, in consideration of a front-back positional relationship between a real space and a virtual space. In Japanese Patent Application Laid-open No. 2015-170232, an information processing apparatus acquires in advance an image (hereinafter, referred to as “captured real image”) obtained by capturing a real space and depth information of the real space. The information processing apparatus determines the front-back positional relationship between a captured real image and a translucent virtual object by using a rendering engine, and then generates an image by performing a rendering process.

In the technique disclosed in Japanese Patent Application Laid-open No. 2015-170232, first, the information processing apparatus converts the captured real image into an object, and then determines the front-back positional relationship between the obtained object and the translucent virtual object by using the rendering engine. This procedure causes an extended display delay time before the captured real image appears on the HMD.

Thus, a method for shortening the time delay when displaying the captured real image may be adopted. In this method, an image of only the virtual object is generated by the rendering engine, and then, the generated image is combined with the latest captured real image. However, this method cannot appropriately express the front-back positional relationship between the captured real image and the translucent virtual object.

### SUMMARY OF THE INVENTION

An object of the present invention is to generate a more appropriate image including a translucent virtual object while reducing the time delay when displaying a captured real image.

An aspect of the present invention is an information processing apparatus including one or more processors and/or circuitry configured to: execute a first acquisition process for acquiring a first layer including a first image in which a translucent object, which is a virtual object having transparency, is drawn and first depth information that corresponds to the first image; execute a second acquisition process for acquiring a second layer including a second image in which an opaque object, which is a virtual object having no transparency, is drawn and second depth information that corresponds to the second image; execute a third acquisition process for acquiring a third layer including a third image in which a real object, which is placed in a real space, is drawn and third depth information that corresponds to the third image; and execute a composition process for drawing a composite image in which the first image, the second image, and the third image are combined on a basis of the first depth information, the second depth information, and the third depth information.

An aspect of the present invention is an information processing method including: a first acquisition step of acquiring a first layer including a first image in which a translucent object, which is a virtual object having transparency, is drawn and first depth information that corresponds to the first image; a second acquisition step of acquiring a second layer including a second image in which an opaque object, which is a virtual object having no transparency, is drawn and second depth information that corresponds to the second image; a third acquisition step of acquiring a third layer including a third image in which a real object, which is placed in a real space, is drawn and third depth information that corresponds to the third image; and a composition step of drawing a composite image in which the first image, the second image, and the third image are combined on a basis of the first depth information, the second depth information, and the third depth information.

Further features of the present invention will become apparent from the following description of exemplary embodiments with reference to the attached drawings.

### BRIEF DESCRIPTION OF THE DRAWINGS

FIG. 1 is a diagram illustrating a hardware configuration of an information processing apparatus according to Embodiment 1;

FIG. 2 is a functional block diagram of the information processing apparatus according to Embodiment 1;

FIGS. 3A and 3B are diagrams for describing a composite image according to Embodiment 1;

FIGS. 4A to 4C are diagrams illustrating examples of images according to Embodiment 1;

FIGS. 5A to 5C are diagrams for describing another composite image according to Embodiment 1;

FIG. 6 is a flowchart of a CG layer acquisition process according to Embodiment 1;

FIG. 7 is a flowchart of a layer correction process according to Embodiment 1;

FIG. 8 is a flowchart of a layer generation process according to Embodiment 1; and

FIG. 9 is a flowchart of an image composition process according to Embodiment 1.

### DESCRIPTION OF THE EMBODIMENTS

Hereinafter, embodiments according to the present invention will be described with reference to the drawings. The following embodiments do not limit the present invention, and not all combinations of features described in the embodiments are necessarily essential to the solving means of the present invention. The configuration of each embodiment can be appropriately modified or changed according to the specification and various conditions (use conditions, use environments, and the like) of the apparatus to which the invention is applied. Further, parts of each embodiment described below may be appropriately combined. In the following embodiments, the same components are denoted by the same reference numerals.

### Embodiment 1

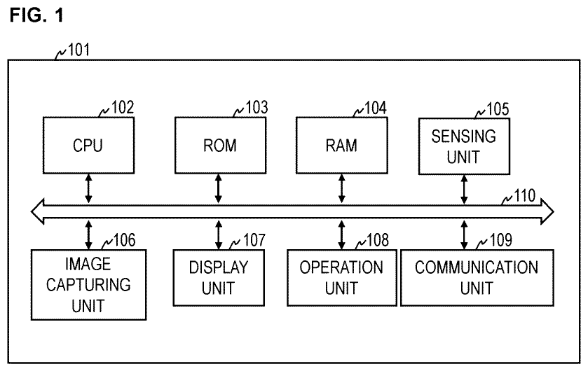

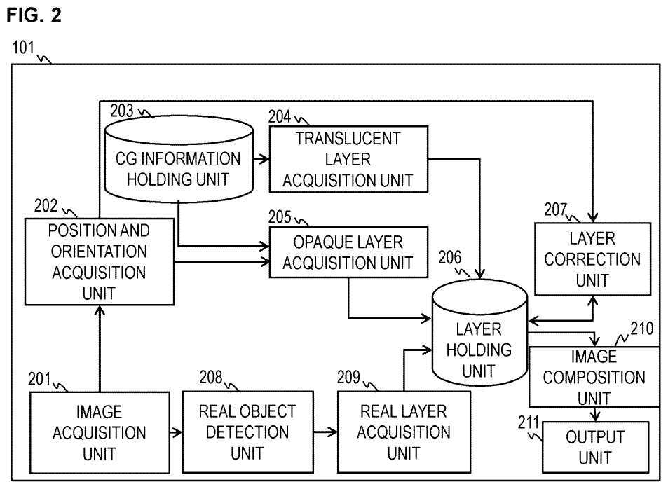

FIG. 1 is a diagram illustrating an example of a hardware configuration of an information processing apparatus 101 according to Embodiment 1. FIG. 2 is a functional block diagram illustrating a functional configuration of the information processing apparatus 101 according to Embodiment 1.

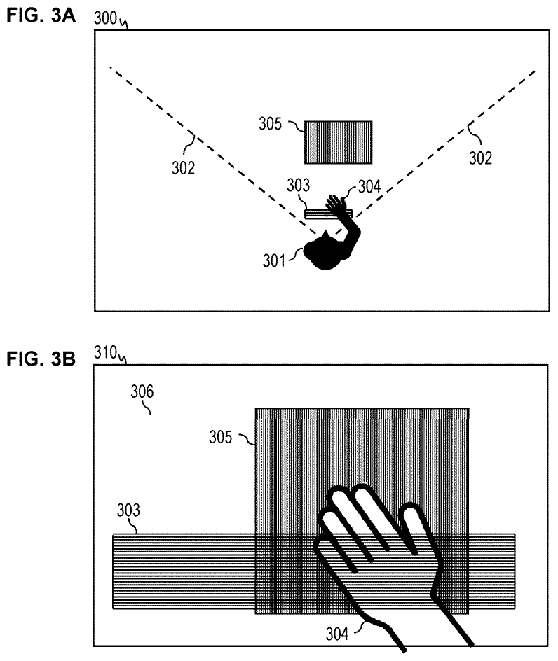

First, an image (a composite image) obtained by combining a captured real image and a virtual object will be described with reference to FIGS. 3A and 3B. In the present embodiment, the case where a hand of a user (hereinafter, referred to as a “hand”) and a virtual object are displayed on the HMD worn by the user will be described as an example.

FIG. 3A illustrates an MR space 300, which is an MR space experienced by a user 301 wearing the information processing apparatus 101, the MR space being seen from the above. An angle of view 302 is a range visually recognized by the user 301 via the information processing apparatus 101. A translucent object 303 is a virtual object having transparency. A hand 304 is a hand of the user 301. The user 301 visually recognizes his/her own hand 304 as a part of the captured real image. An opaque object 305 is a virtual object having no transparency. The translucent object 303, the hand 304, and the opaque object 305 are placed in this order at increasing distances from the user 301 as a reference point.

FIG. 3B illustrates a display image 310, which is an image displayed on the information processing apparatus 101. The display image 310 represents the front- back positional relationship between the “real object” and the “virtual objects including the translucent object 303” in the MR space 300. A background 306 is a captured real image. While the background 306 is a captured real image as an example in the present embodiment, the background may be a background representing a virtual space formed by virtual objects.

In FIG. 3B, the translucent object 303, the hand 304, the opaque object 305, and the background 306 are arranged in this order from the front. The translucent object 303 has transparency. Therefore, in the area where “the hand 304, the opaque object 305, and the background 306” and the translucent object 303 overlap each other, color information about the transparency of the translucent object 303 is combined. On the other hand, since the hand 304 and the opaque object 305 do not have transparency, information about the image behind these objects is occluded so that the image becomes invisible.

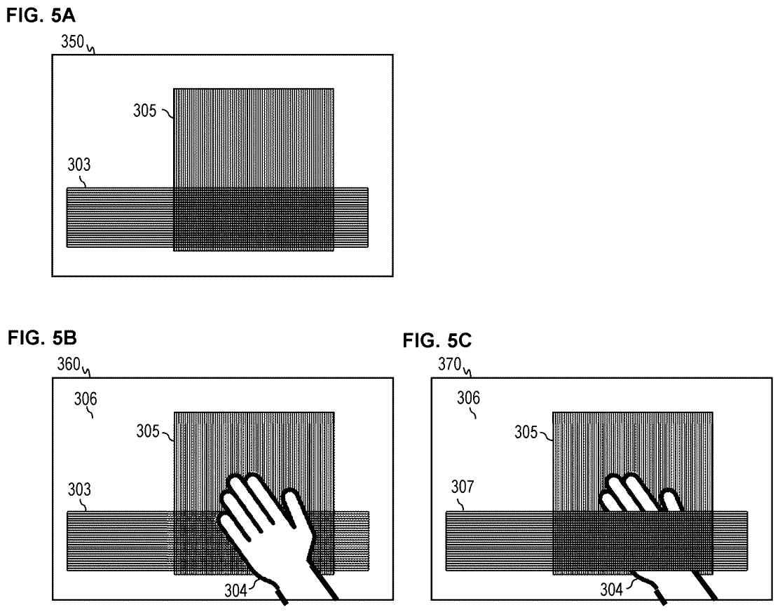

Therefore, if an image 360 illustrated in FIG. 5B or an image 370 illustrated in FIG. 5C is displayed despite that fact that the translucent object 303, the hand 304, and the opaque object 305 are arranged in the positional relationship as illustrated in FIG. 3A, the displayed image has an inappropriate positional relationship. For example, a case different from Embodiment 1 will be considered. In this case, the translucent object 303 and the opaque object 305 are collectively represented by a single virtual image 350 illustrated in FIG. 5A, and depth information corresponding to this virtual image is acquired. In such a case, because the depth of the translucent object 303 is normally ignored, the depth information indicates the depth corresponding to the opaque object 305 in the area where the translucent object 303 and the opaque object 305 overlap each other. Thus, the depth information cannot reflect the appropriate positional relationship between the translucent object 303 and the opaque object 305. As a result, when the hand 304 is combined with the virtual image 350, as illustrated in FIG. 5B, the image 360 in which the hand 304 is positioned at the forefront is generated.

FIG. 1 illustrates a hardware configuration of the information processing apparatus 101 as an example of the HMD used by the user. The information processing apparatus 101 includes a central processing unit (CPU) 102, a read-only memory (ROM) 103, a random access memory (RAM) 104, a sensing unit 105, an image capturing unit 106, a display unit 107, an operation unit 108, and a communication unit 109. The constituent elements are connected to each other via a bus 110.

The CPU 102 is an arithmetic processing unit that comprehensively controls the information processing apparatus 101. The CPU 102 executes various programs stored in the ROM 103 or the like to perform various kinds of processing.

The ROM 103 stores programs (such as image processing programs and initial data) and parameters that do not need to be changed. The ROM 103 is a read-only nonvolatile memory device.

The RAM 104 temporarily stores input information, computation results in image processing, etc. The RAM 104 is a memory device that provides the CPU 102 with a workspace.

The sensing unit 105 is a device such as a sensor. The sensing unit 105 acquires information on the position and orientation of the user of the information processing apparatus 101 by detecting the rotation, inclination, and movement amount of the head of the user. The sensing unit 105 may acquire hand tracking information of the user of the information processing apparatus 101 and information (model data, depth information, or position and orientation information) about a real object in the surrounding area by using an infrared sensor or the like.

The image capturing unit (imaging unit) 106 is an image capturing device that acquires a captured image by capturing (imaging) an image of a real space. The image capturing unit 106 is a built-in camera of the HMD, a web camera connected to the PC, or the like.

The display unit 107 is a liquid crystal display or the like. The display unit 107 displays captured images, virtual objects, characters, items, etc.

The operation unit 108 is an operation unit including an operation member such as a power button or a dial. The operation unit 108 may include a keyboard or a mouse.

The communication unit 109 performs data transmission and reception with an external device by wired communication or wireless communication (a wireless local area network (LAN), a local 5G, or the like). In the present embodiment, the communication unit 109 can transmit the position and orientation information detected by the HMD of the user and receive information (model data, position and orientation information, etc.) about the real object detected by another device, via the network.

FIG. 2 is a functional block diagram of the information processing apparatus 101. The information processing apparatus 101 includes an image acquisition unit 201, a position and orientation acquisition unit 202, a computer graphics (CG) information holding unit 203, a translucent layer acquisition unit 204, an opaque layer acquisition unit 205, a layer holding unit 206, and a layer correction unit 207. The information processing apparatus 101 includes a real object detection unit 208, a real layer acquisition unit 209, an image composition unit 210, and an output unit 211.

The functional configuration illustrated in FIG. 2 can be realized by the CPU 102 executing a program. However, the CPU 102 does not need to implement all the functions. For example, the information processing apparatus 101 may include a dedicated processing circuit that implements one or more functions.

The image acquisition unit 201 acquires an image obtained by capturing a real space by the image capturing unit 106 as a captured real image.

The position and orientation acquisition unit 202 acquires information about the position, orientation, speed, and acceleration of the HMD worn by the user 301 as position and orientation information from the sensing unit 105, etc. The position and orientation acquisition unit 202 may acquire “information about the self-position of the HMD calculated by using a self-position estimation technique based on a captured real image acquired from the image acquisition unit 201” as the position and orientation information.

The CG information holding unit 203 holds CG information needed for rendering a plurality of virtual objects (CG) including a translucent object. The CG information includes model data of each virtual object, position and orientation information, color information including a degree of transparency, and camera viewpoint information (information such as a position, an angle of view, and resolution) for drawing the virtual objects.

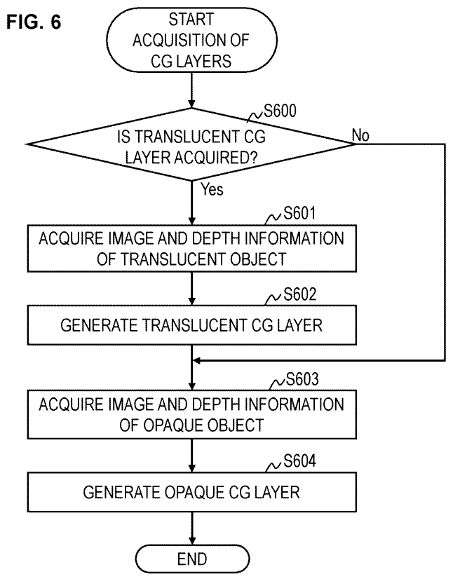

The translucent layer acquisition unit 204 acquires a translucent CG layer from a rendering engine based on the “position and orientation information acquired from the position and orientation acquisition unit 202” and the “CG information acquired from the CG information holding unit 203”. The translucent CG layer includes an image of a translucent object and depth information corresponding to the image. The details of the process executed by the translucent layer acquisition unit 204 will be described below with reference to the flowchart in FIG. 6.

The opaque layer acquisition unit 205 acquires an opaque CG layer from the rendering engine based on the “position and orientation information acquired from the position and orientation acquisition unit 202” and the “CG information acquired from the CG information holding unit 203”. The opaque CG layer includes an image of an opaque object and depth information corresponding to the image. The details of the process executed by the opaque layer acquisition unit 205 will be described below with reference to the flowchart in FIG. 6.

The layer holding unit 206 holds the translucent CG layer and the opaque CG layer as CG layers. In addition, the layer holding unit 206 also holds a real object layer acquired by the real layer acquisition unit 209. The real object layer includes an image of a real object and depth information corresponding to the image.

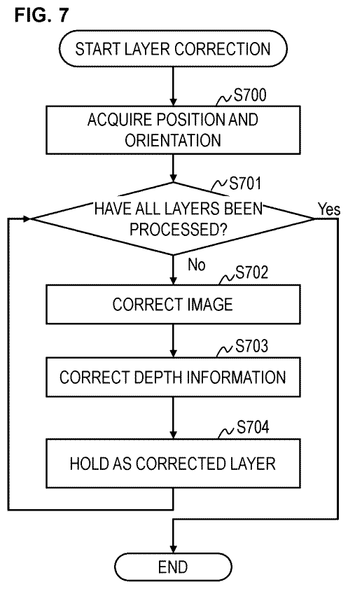

The layer correction unit 207 corrects the “images and depth information” held as the CG layers in the layer holding unit 206 based on the latest position and orientation information about the HMD. The details of the process executed by the layer correction unit 207 will be described below with reference to the flowchart in FIG. 7. In the present embodiment, as an example, a case where the layer correction unit 207 corrects the CG layers acquired by the translucent layer acquisition unit 204 and the opaque layer acquisition unit 205 will be described. However, the layer correction unit 207 may correct the real object layer acquired by the real layer acquisition unit 209.

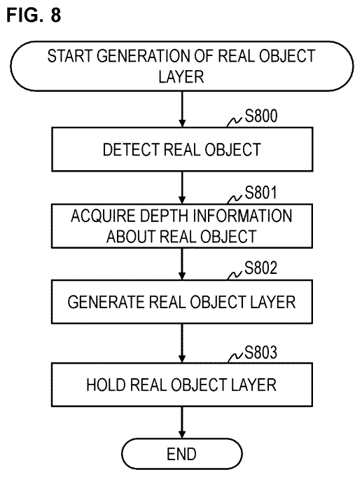

The real object detection unit 208 acquires information about a real object placed in the real space based on the captured real image or the like acquired from the image acquisition unit 201. The details of the process executed by the real object detection unit 208 will be described below with reference to the flowchart in FIG. 8.

The real layer acquisition unit 209 acquires a real object layer based on the information about the real object acquired by the real object detection unit 208. The real layer acquisition unit 209 stores the real object layer in the layer holding unit 206. The details of the process executed by the real layer acquisition unit 209 will be described below with reference to the flowchart in FIG. 8.

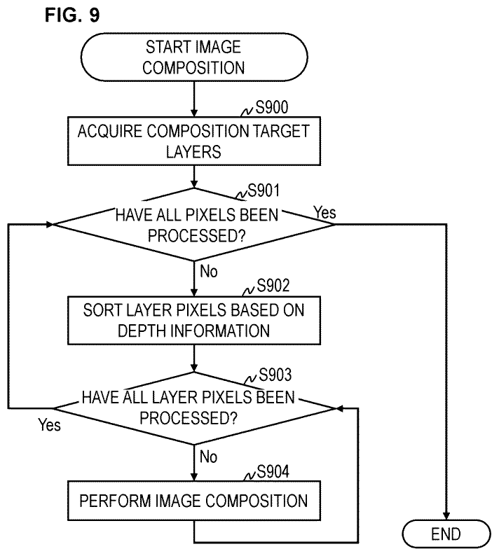

The image composition unit 210 generates a composite image based on “the CG layers and the real object layer” held in the layer holding unit 206. The details of the process executed by the image composition unit 210 will be described below with reference to the flowchart in FIG. 9.

The output unit 211 displays the composite image generated by the image composition unit 210 on the display unit 107. Thus, the output unit 211 presents the composite image to the user 301.

### Process Executed by Translucent Layer Acquisition Unit and Opaque Layer Acquisition Unit

An example of the details of a CG layer acquisition process executed by the translucent layer acquisition unit 204 and the opaque layer acquisition unit 205 will be described with reference to the flowchart in FIG. 6.

In step S600, the translucent layer acquisition unit 204 determines whether to acquire (generate) a translucent CG layer related to the translucent object. If it is determined to acquire (generate) a translucent CG layer, the process proceeds to step S601. If it is determined not to acquire (generate) a translucent CG layer, the process proceeds to step S603.

For example, the translucent layer acquisition unit 204 determines to acquire the translucent CG layer only in a first case, and determines not to acquire the translucent CG layer in a second case, which is a case other than the first case. The first case is, for example, a case where the translucent object is positioned within a drawing area of a composite image. The first case may also be a case where a degree of transparency (an alpha value indicating transparency) of the translucent object exceeds a preset first threshold. The first case may be a case where the distance between the translucent object and the user 301 exceeds a preset second threshold. The first case may be a case where the ratio of the drawing area of the translucent object to the drawing area of the composite image exceeds a preset third threshold. The first case may be a case where the translucent object is positioned nearer to the front side than the hand 304 is. The first case may be a case where the translucent object and another virtual object overlap each other in the composite image. Note that the first case may be a case where at least one of the above cases described as the examples of the first case is satisfied, or may be a case where a plurality of the above cases are satisfied.

It can be said that the examples of the first case described above are each a case where it is highly necessary to place the translucent object at an appropriate position in the composite image. In such a case, the processing in step S601 and the subsequent steps is performed so that the translucent object can be appropriately displayed in the composite image. On the other hand, in cases other than the examples of the first case described above, even if “the position of the translucent object is somewhat inaccurate” or “the translucent object is handled in the same manner as the opaque object”, the user is unlikely to feel a sense of incongruity when viewing the composite image. Therefore, the necessity of specially acquiring a translucent CG layer is low. According to the present embodiment, the amount of processing can be reduced. Thus, the processing efficiency of generating a composite image is improved.

In step S601, the translucent layer acquisition unit 204 acquires a CG image and depth information of the translucent object based on the “position and orientation information obtained from the position and orientation acquisition unit 202” and the “CG information obtained from the CG information holding unit 203”.

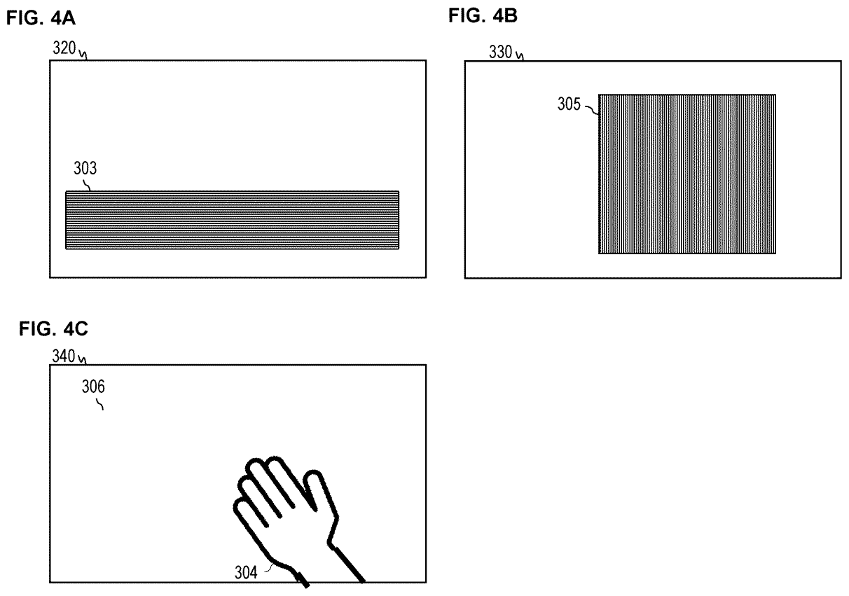

Specifically, first, the translucent layer acquisition unit 204 acquires a CG image of the translucent object that has been rendered by the rendering engine. The CG image 320 illustrated in FIG. 4A is an example of the CG image of the translucent object that has been rendered, and the translucent object 303 having transparency has been drawn in the CG image 320.

Next, the translucent layer acquisition unit 204 acquires depth information of the translucent object that has been rendered by the rendering engine. The depth information about the translucent object is information indicating the depth of each pixel (each location) of the CG image of the translucent object, and the screen resolution (the aspect ratio and the number of pixels) of the depth information and the screen resolution of the CG image correspond to each other.

In step S602, the translucent layer acquisition unit 204 obtains a combination of the CG image and the depth information of the translucent object acquired in step S601 as a translucent CG layer. Thus, the translucent CG layer has the CG image and the depth information of the translucent object.

In step S603, the opaque layer acquisition unit 205 determines that objects other than the translucent object rendered in step S601 are opaque objects. Thus, for example, if it is determined not to acquire the translucent CG layer in step S600, an object having transparency could be determined as an opaque object. Next, the opaque layer acquisition unit 205 acquires the CG image and the depth information of the opaque object.

Specifically, first, the opaque layer acquisition unit 205 acquires a CG image of the opaque object that has been rendered by the rendering engine based on the position and orientation information and the CG information. The CG image 330 illustrated in FIG. 4B is an example of the CG image of the opaque object that has been rendered, the opaque object 305 has been drawn in the CG image 330.

Next, the opaque layer acquisition unit 205 acquires depth information about the opaque object that has been rendered by the rendering engine. The depth information about the opaque object is information indicating the depth of each pixel (each location) of the CG image of the opaque object, and the screen resolution (the aspect ratio and the number of pixels) of the depth information and the screen resolution of the CG image correspond to each other.

In step S604, the opaque layer acquisition unit 205 obtains (generates) a combination of the CG image and the depth information of the opaque object acquired in step S603 as an opaque CG layer. Thus, the opaque CG layer has the CG image and the depth information of the opaque object.

Note that, in the process following the process of this flowchart, the “translucent CG layer generated in step S602” and the “opaque CG layer generated in step S604” are used without making any distinction therebetween. Thus, the translucent CG layer and the opaque CG layer will collectively be referred to as “CG layers”.

In the description of steps S600 to S602, the case where only one translucent CG layer is generated has been described as an example. However, the number of translucent CG layers is not limited to one. For example, a plurality of translucent objects may be divided into arbitrary groups, and translucent CG layers may be generated for the respective groups. Similarly, the number of opaque CG layers is not limited to one, and a plurality of opaque CG layers may be generated.

### Process Executed by Layer Correction Unit

An example of the details of a layer correction process executed by the layer correction unit 207 will be described with reference to the flowchart in FIG. 7.

In step S700, the layer correction unit 207 acquires the position and orientation information of the latest or any frame from the position and orientation acquisition unit 202.

In step S701, the layer correction unit 207 determines whether the processing in step S702 and the subsequent steps has been already performed on all the layers held by the layer holding unit 206. If it is determined that the processing in step S702 and the subsequent steps has already been performed on all the layers, the process of this flowchart ends. If it is determined that the processing in step S702 and the subsequent steps has not been performed on at least one of all the layers, the layer correction unit 207 selects one layer from the one or more layers on which it has been determined that the processing in step S702 and the subsequent steps has not been performed. The layer selected by the layer correction unit 207 will be referred to as a “selected layer”. Next, the process proceeds to step S702.

In step S702, the layer correction unit 207 estimates the position and orientation of each virtual object based on the position and orientation information acquired in step S700. The layer correction unit 207 corrects the position and orientation of the virtual object corresponding to the selected layer in the CG image of the selected layer based on the estimation result. In this way, the layer correction unit 207 corrects the CG image of the selected layer.

In step S703, the layer correction unit 207 estimates the position and orientation of each virtual object based on the position and orientation information acquired in step S700. The layer correction unit 207 corrects the depth information of the selected layer based on the estimation result.

In step S704, the layer correction unit 207 stores a combination of the “CG image corrected in step S702” and the “depth information corrected in step S703” as a “corrected layer” in the layer holding unit 206. In this step, the layer correction unit 207 may overwrite the “selected layer” stored in the layer holding unit 206 with the “corrected layer”.

### Process Executed by Real Layer Detection Unit and Real Layer Acquisition Unit

An example of the details of a layer generation process executed by the real object detection unit 208 and the real layer acquisition unit 209 will be described with reference to the flowchart in FIG. 8.

In step S800, the real object detection unit 208 acquires information about a real object such as a hand in a captured real image obtained by the image acquisition unit 201. In Embodiment 1, the real object detection unit 208 detects the area of the hand in the captured real image by performing image processing or the like on the captured real image.

The captured real image 340 illustrated in FIG. 4C is an example of the captured real image obtained by the image acquisition unit 201, and the hand 304 and the background 306 detected by the real object detection unit 208 have been drawn in the captured real image 340. Note that, in the present embodiment, the case where the hand 304 is the real object to be detected will be described as an example. However, the real object to be detected may be a body part such as a foot of the user 301, a person other than the user 301, or furniture such as a desk or a chair.

In step S801, the real object detection unit 208 acquires depth information about the “real object detected in step S800”. For example, the depth information can be acquired by stereo matching or the like using a plurality of captured real images obtained by capturing the real space from a plurality of viewpoints corresponding to the right eye and the left eye. The real object detection unit 208 may use the depth information about the real object acquired from the sensing unit 105. The real object detection unit 208 may acquire the depth information about the real object detected by another device via the communication unit 109. The depth information about the real object is information indicating the depth of each pixel (each location) of the captured real image of the real object, and the screen resolution (the aspect ratio and the number of pixels) of the depth information and the screen resolution of the captured real image correspond to each other.

In step S802, the real layer acquisition unit 209 generates a combination of the captured real image obtained in step S800 and the depth information obtained in step S801 as a real object layer. The real object layer includes the captured real image in which the real object is captured and the depth information about the real object.

In step S803, the real layer acquisition unit 209 holds the real object layer generated in step S802 in the layer holding unit 206.

In the description of steps S800 to S802, the case where only one real object layer is generated has been described as an example. However, the number of real object layers is not limited to one. For example, a plurality of real objects may be divided into arbitrary groups, and real object layers may be generated for the respective groups.

### Process Executed by Image Composition Unit

An example of the details of an image composition process executed by the image composition unit 210 will be described with reference to the flowchart in FIG. 9. The image composition unit 210 generates a composite image by combining the image of the translucent object, the image of the opaque object, and the image of the real object. In the present embodiment, a composite image having an appropriate front- back positional relationship can be generated by sequentially drawing (combining) pixels of respective images in order from the pixel on the deeper side to the pixel on the nearer side based on the depth information of each layer.

In step S900, the image composition unit 210 acquires a plurality of layers (hereinafter, referred to as a “layer list”) to be used for the composition from the layer holding unit 206. The layer list includes CG layers and real object layers. At this point, if the layer correction unit 207 has executed a correction on a layer, the layer list includes the corrected layer instead of the layer before the correction. Note that, in every layer held in the layer list, the image and the depth information held in each layer shares the same screen resolution (the aspect ratio and the number of pixels).

In step S901, the image composition unit 210 determines whether the processing in step S902 and the subsequent steps has been performed on all the pixels of the composite image. If it is determined that the processing in step S902 and the subsequent steps has been performed on all the pixels, the process of this flowchart ends. If it is determined that the processing in step S902 and the subsequent steps has not been performed on at least one pixel, the processing in step S902 and the subsequent steps is performed on the one pixel on which the processing in step S902 and the subsequent steps has not yet been performed. Hereinafter, a pixel (a pixel of depth information) to be processed in step S902 and the subsequent steps will be referred to as a “selected pixel”.

In step S902, the image composition unit 210 acquires a pixel (hereinafter, referred to as a “layer pixel”) of the image held in each layer in the layer list, the pixel being positioned at the coordinates of the selected pixel (hereinafter, referred to as “selected coordinates”) in the composite image. Next, the image composition unit 210 sorts the acquired one or more layer pixels in descending order of value of the depth information. Thus, the layer pixels are arranged in order of distance from the user 301, from the farthest to the nearest to the user 301.

For example, a case where a first pixel of the composite image has been selected as a selected pixel will be considered. In this case, it is further assumed that a second pixel of the translucent object 303, a third pixel of the hand 304, and a fourth pixel of the opaque object 305 are positioned at the coordinates of the selected pixel. In such a case, in step S902, the image composition unit 210 arranges these three pixels in descending order of value of the depth information at the selected coordinates, that is, the image composition unit 210 arranges these three pixels in the order of the fourth pixel, the third pixel, and the second pixel.

In step S903, the image composition unit 210 performs a control operation such that the processing in step S904 is sequentially performed on the layer pixels that have been sorted in descending order in step S902. Specifically, in step S903, the image composition unit 210 determines whether the processing in step S904 has been performed on all the layer pixels. If it is determined that the processing in step S904 has been performed on all the layer pixels, the process proceeds to step S901. If not, the processing in step S904 is performed on a layer pixel (hereinafter, referred to as a “drawing target pixel”) having the largest value of the depth information among one or more layer pixels on which the processing in step S904 has not been performed. Note that “if not” refers to a case where it is determined that the processing in step S904 has not been performed on at least any one of the layer pixels.

In step S904, the image composition unit 210 draws the pixel at the coordinates of the selected pixel in the composite image by applying the color information about the drawing target pixel. In this step, the image composition unit 210 performs alpha blending by using the value indicating the transparency of the drawing target pixel. In this way, image composition in consideration of transparency can be achieved.

For example, it is assumed that, at a certain selected pixel, the fourth pixel of the opaque object 305, the third pixel of the hand 304, and the second pixel of the translucent object 303 have been sorted in this order in step S902. In this case, the image composition unit 210 sequentially performs the drawing of the fourth pixel, the drawing of the third pixel, and the drawing of the second pixel in this order by repeating the processing in step S903 and step S904. In this way, the image composition unit 210 draws the pixels at the coordinates of the selected pixel in the composite image.

As described above, when composition of an image including a layer of a real object is performed, a composite image in which the front-back positional relationship is appropriately expressed can be generated by generating a layer of a translucent object separately from a layer of an opaque object. Further, a layer of a virtual object can be acquired by a process different from the detection process of the real object. As a result, the time delay when displaying a captured real image can also be reduced.

According to the present invention, a more appropriate image including a translucent virtual object can be generated while the time delay when displaying a captured real image is reduced.

In the above description, “if A is equal to or more than B, the process proceeds to step S1, and if A is smaller (lower) than B, the process proceeds to step S2” may be read as “if A is larger (higher) than B, the process proceeds to step S1, and if A is equal to or less than B, the process proceeds to S2”. Conversely, “if A is larger (higher) than B, the process proceeds to step S1, and if A is equal to or less than B, the process proceeds to step S2” may be read as “if A is equal to or more than B, the process proceeds to step S1, and if A is smaller (lower) than B, the process proceeds to step S2”. Thus, unless a contradiction arises, “equal to or more than A” may be read as “larger (higher; longer; more) than A”, and “equal to or less than A” may be read as “smaller (lower; shorter; less) than A”. In addition, “larger (higher; longer; more) than A” may be read as “equal to or more than A”, and “smaller (lower; shorter; less) than A” may be read as “equal to or less than A”.

The various above mentioned controls may or may not be performed by one hardware device (e.g. processor or circuit). A plurality of hardware devices (e.g. a plurality of processors, a plurality of circuits or a combination of one or more processors and one or more circuits) may share the processing to control the entire apparatus.

The above mentioned processor is a processor in a wide sense, and includes a general purpose processor and a dedicated processor. The general purpose processor is, for example, a central processing unit (CPU), a micro processing unit (MPU), a digital signal processor (DSP), or the like. The dedicated processor is, for example, a graphics processing unit (GPU), an application specific integrated circuit (ASIC), a programmable logic device (PLD), or the like. The programmable logic device is, for example, a field programmable gate array (FPGA), a complex programmable logic device (CPLD), or the like.

Whereas embodiments of the present invention have been described, the present invention is not limited to these specific embodiments, but also include various modes in a range not departing from the spirit of the invention. Further, each of the above embodiments is merely an example of the present invention, and each embodiment may be appropriately combined.

In the above-mentioned embodiments, a case of applying the present invention to an information processing apparatus was described as an example. However, the present invention is not limited to this example and is applicable to any electronic apparatus capable of displaying composite images. The electronic apparatus may be a computer, a smartphone, a tablet terminal, a digital camera, or home electronic equipment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-055620, filed on Mar. 29, 2024, which is hereby incorporated by reference herein in its entirety.

What is claimed is:

1. An information processing apparatus comprising one or more processors and/or circuitry configured to:
execute a first acquisition process for acquiring a first layer including a first image in which a translucent object, which is a virtual object having transparency, is drawn and first depth information that corresponds to the first image;
execute a second acquisition process for acquiring a second layer including a second image in which an opaque object, which is a virtual object having no transparency, is drawn and second depth information that corresponds to the second image;
execute a third acquisition process for acquiring a third layer including a third image in which a real object, which is placed in a real space, is drawn and third depth information that corresponds to the third image; and
execute a composition process for drawing a composite image in which the first image, the second image, and the third image are combined on a basis of the first depth information, the second depth information, and the third depth information.

2. The information processing apparatus according to claim 1, wherein, in the first acquisition process, the first layer is acquired in case where the translucent object is positioned within a drawing area of the composite image.

3. The information processing apparatus according to claim 1, wherein, in the first acquisition process, the first layer is acquired in case where a degree of transparency of the translucent object exceeds a first threshold.

4. The information processing apparatus according to claim 1, wherein, in the first acquisition process, the first layer is acquired in case where a distance between the translucent object and a user exceeds a second threshold.

5. The information processing apparatus according to claim 1, wherein, in the first acquisition process, the first layer is acquired in case where a ratio of a drawing area of the translucent object to a drawing area of the composite image exceeds a third threshold.

6. The information processing apparatus according to claim 1, wherein, in the first acquisition process, the first layer is acquired in case where the translucent object is positioned closer to a front side than the real object.

7. The information processing apparatus according to claim 1, wherein the one or more processors and/or circuitry further configured to execute a position and orientation acquisition process for acquiring information about position and orientation of a user.

8. The information processing apparatus according to claim 7, wherein the one or more processors and/or circuitry further configured to execute a correction process for correcting the first layer, the second layer, and the third layer based on the position and orientation of the user.

9. The information processing apparatus according to claim 1, wherein the one or more processors and/or circuitry further configured to:
execute an image acquisition process for acquiring a captured image obtained by capturing the real space including the real object; and
acquire, in the third acquisition process, the third layer based on the captured image.

10. The information processing apparatus according to claim 1, wherein, in the composition process, the composite image in which the first image, the second image, and the third image are combined is drawn on a basis of the first depth information, the second depth information, and the third depth information and on a basis of a value indicating transparency of an individual pixel.

11. The information processing apparatus according to claim 1, wherein, in the composition process, in case where a first pixel of the first image, a second pixel of the second image, and a third pixel of the third image are positioned at identical coordinates, drawing is performed in descending order of depth corresponding to each of the first pixel, the second pixel, and the third pixel.

12. An information processing method comprising:
a first acquisition step of acquiring a first layer including a first image in which a translucent object, which is a virtual object having transparency, is drawn and first depth information that corresponds to the first image;
a second acquisition step of acquiring a second layer including a second image in which an opaque object, which is a virtual object having no transparency, is drawn and second depth information that corresponds to the second image;
a third acquisition step of acquiring a third layer including a third image in which a real object, which is placed in a real space, is drawn and third depth information that corresponds to the third image; and
a composition step of drawing a composite image in which the first image, the second image, and the third image are combined on a basis of the first depth information, the second depth information, and the third depth information.

13. A non-transitory computer readable medium that stores a program, wherein the program causes a computer to execute an information processing method, the information processing method comprising:
a first acquisition step of acquiring a first layer including a first image in which a translucent object, which is a virtual object having transparency, is drawn and first depth information that corresponds to the first image;
a second acquisition step of acquiring a second layer including a second image in which an opaque object, which is a virtual object having no transparency, is drawn and second depth information that corresponds to the second image;
a third acquisition step of acquiring a third layer including a third image in which a real object, which is placed in a real space, is drawn and third depth information that corresponds to the third image; and
a composition step of drawing a composite image in which the first image, the second image, and the third image are combined on a basis of the first depth information, the second depth information, and the third depth information.
